(19) United States
(12) Patent Application Publication
(10) Pub. No.: US 2007/0027971 A1
(43) Pub. Date: Feb. 1, 2007

(54) Device management network with notifications comprising multiple choice prompts

(76) Inventors: Sunil Marolia, Laguna Niguel, CA (US); Bindu Rama Rao, Laguna Niguel, CA (US)

Correspondence Address: Kevin Borg;McAndrews, Held & Malloy, Ltd., 500 W. Madison St., Chicago, IL, 60661, US

(21) Appl. No.: 11/189,944

(22) Filed: Jul. 26, 2005

(51) Int. Cl. G06F 15/173

(52) U.S. Cl. 709/223

(57) ABSTRACT

The notification client in a mobile device is sent a notification message by a DM server to indicate the need to conduct a device management task on the mobile device. In response, the notification client displays the message received, which could be a multiple choice message. The user's response is also solicited. When the user responds, the user's response is communicated back to the DM server, or to another server. The user response may be communicated over one of the available communication means, such as SMS, a DM session over a OMA DM protocol, etc. In general, if a multiple choice message is displayed by the notification client, the user's selection is communicated to the DM server.

### RELATED APPLICATIONS

The present application makes reference to, is a continuation of, and claims benefit of U.S. Provisional Patent Application, Attorney Docket Number 101USMD103, entitled “UPDATE SYSTEM CAPABLE OF UPDATING SOFTWARE”, filed 9 Aug. 2004, the complete subject matter of which is hereby incorporated herein by reference, in its entirety.

The present application makes reference to PCT Application having publication number WO/02/41147 A1 and PCT Application No. PCT/US01/44034, entitled “System and Method for Updating and Distributing Information”, filed Nov. 19, 2001, the complete subject matter of which is hereby incorporated herein by reference, in its entirety.

The present application also makes reference to U.S. Provisional Patent Application Ser. No. 60/249,606, entitled “System and Method for Updating and Distributing Information”, filed Nov. 17, 2000, the complete subject matter of which is hereby incorporated herein by reference, in its entirety.

### FEDERALLY SPONSORED RESEARCH OR DEVELOPMENT

[Not Applicable]

### MICROFICHE/COPYRIGHT REFERENCE

[Not Applicable]

### BACKGROUND OF THE INVENTION

Electronic devices, such as mobile phones and personal digital assistants (PDA's), often contain firmware and application software that are either provided by the manufacturers of the electronic devices, by telecommunication carriers, or by third parties. The software and firmware in electronic devices have bugs, and quite often, these bugs inhibit proper operation of the electronic device by a user.

When a device management (DM) server, such as those in an operator network, needs to conduct a management task on a device, often the device may not be aware of that need. The DM server may not have the means to let the device know that it has to be managed. Informing a device that it needs to be managed, such as by changing a configuration or updating a firmware component, is a big problem. In addition, informing the device that the user needs to opt-in is another problem that needs to be solved. Providing relevant information to a user to educate the user on the need to conduct a DM activity is another problem that must be solved. Again, a DM server needs to be able to interact with several different device of different make and model. Often, it is not good to have a different solution for each make and model of a device. However, each device behaves differently and trying to support different user interface features in different devices is not a trivial task.

If firmware or firmware components are to be changed, it is often very tricky to update the firmware components in an electronic device. The electronic device must have sufficient memory available to download an update package and to execute an update process. Changes to firmware or firmware components of the electronic device must be performed in a fault tolerant mode and fault tolerant code are not easy to implement. Typically, changing or updating a firmware of a device is mush more complicated than a typically software installation. Any failure to properly conduct the update results in the device becoming inoperable.

Typically, attempts to upgrade firmware and/or software in electronic devices, such as GSM mobile phones, are often hampered by the need to have an embedded program that can conduct the update. Devices do not have the same user interface features and seeking user opt-in for firmware updates from users of several different types of devices is a complicated task, requiring device specific knowledge on the server side.

Addressing firmware updates across various types of make and model of electronic devices is a big challenge and is currently not easily solved. In addition, some electronic devices may not have sufficient memory to store a large update package or to conduct updates. Seeking a user opt-in for conducting firmware updates is likely to be confusing to the user if the firmware update operation is not likely to succeed.

Further limitations and disadvantages of conventional and traditional approaches will become apparent to one of skill in the art, through comparison of such systems with some aspects of the present invention as set forth in the remainder of the present application with reference to the drawings.

### BRIEF SUMMARY OF THE INVENTION

A method and/or device supporting firmware and/or software update using an update agent in a mobile electronic device, substantially as shown in and/or described in connection with at least one of the figures, as set forth more completely in the claims.

These and other advantages, aspects and novel features of the present invention, as well as details of an illustrated embodiment thereof, will be more fully understood from the following description and drawings.

### BRIEF DESCRIPTION OF SEVERAL VIEWS OF THE DRAWINGS

FIG. 1 is a perspective block diagram of an exemplary device management network that comprises DM server and a mobile device capable of receiving notifications and device management commands from the DM server.

FIG. 2A depicts the structure of a representative notification message communicated by the DM server to the device, that comprises a header, a message to be displayed to the user, a URL of a Campaign website page, such as a FOTA campaign website page and a response options.

FIG. 2B is an exemplary response options that is displayed to a user.

FIG. 3 is an exemplary OMA DM message that is used by the DM client to communicate the user opt-in selection to the DM server, the user opt-in selection having been inferred based on user selection of one item from a multiple-choice options presented to the user.

FIG. 4 is another exemplary OMA DM message that is used by the DM client to communicate the user opt-in selection to the DM server, the user opt-in selection having been inferred based on user selection of one item from a multiple-choice options presented to the user.

### DETAILED DESCRIPTION OF THE INVENTION

Aspects of the present invention relate generally to the process of conducting device management tasks, such as updating software/firmware in electronic devices, and more specifically, to the use of a notification message with a multiple choice message to solicit user opt-in to conduct efficient fault tolerant firmware updates in the electronic device. The following discussion makes reference to the term “electronic device” that is used herein to refer to mobile electronic devices such as, for example, a mobile handset, a cellular phone, a personal digital assistant (PDA), a pager, and a personal computer, to name just a few. Although the listed example electronic devices are mobile devices, application of the present invention is not limited in this manner, as representative embodiments of the present invention may be employed in a wide variety of electronic devices, both fixed and mobile.

Electronic devices may be adapted to access servers to retrieve update information for updating memory in the electronic devices. An electronic device may be, for example, a mobile electronic device having firmware/software such as mobile cellular phone handsets, personal digital assistants (PDAs), pagers, MP-3 players, digital cameras, to name just a few. Update information may comprise information that modifies or changes firmware/software and/or software components installed in the electronic device. In a representative embodiment of the present invention, update information may comprise a set of executable instructions for converting a first version of code to an updated/second version of code. The update information may add new services to the electronic device, as desired by a service provider, device manufacturer, or an end-user, and/or may fix bugs (e.g., errors) in the operating code of the electronic device. In a representative embodiment of the present invention, update information may comprise an update package.

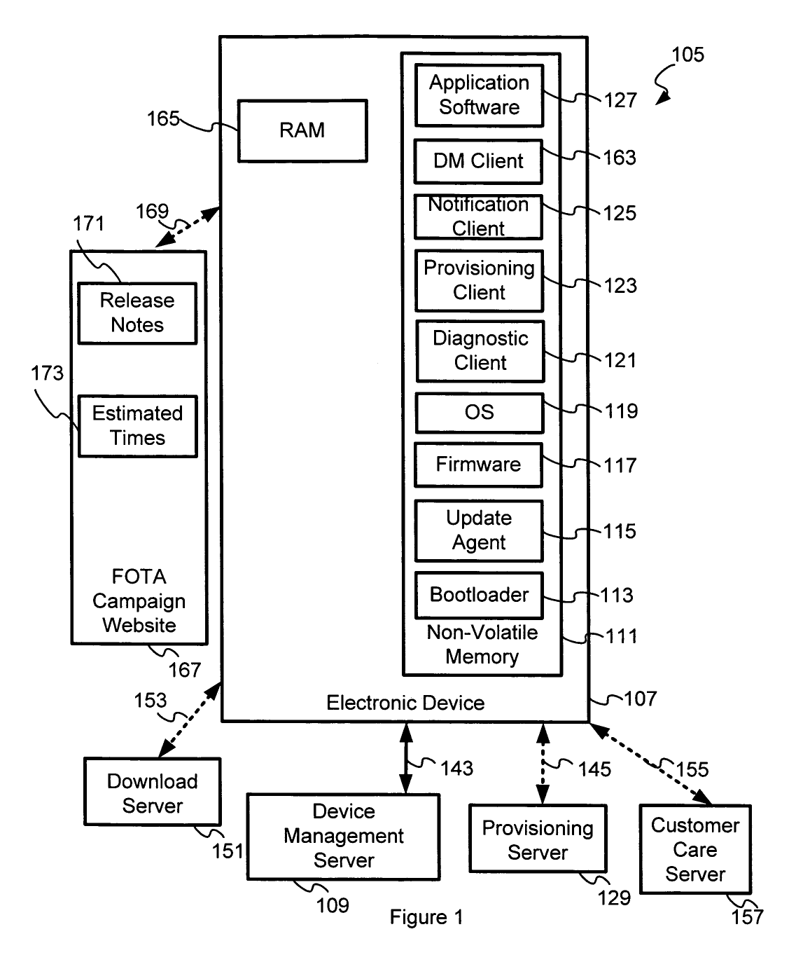

FIG. 1 is a perspective block diagram of an exemplary device management network 105 that comprises DM server 109 and a mobile device 107 capable of receiving notifications and device management commands from the DM server 109. The mobile device 107 comprises a notification client 125 and a device management client 163, in accordance with a representative embodiment of the present invention. The mobile device 107 shown in FIG. 1 also comprises a firmware 117, a random access memory (RAM) 165, and non-volatile memory 121. The RAM 165 and the non-volatile memory 123 may be updated using update information produced by a generator. The device management (DM) network 105 may disseminate the update information in the form of update packages to update the mobile device 107, via a communication path 143, that may comprise, for example, a wired or wireless network such as a cellular network, a paging network, a public switched telephone network (PSTN), and the Internet, to name only a few. The generator, in general, may generate the update information/update packages using a first binary code image (i.e., first code version) and a second binary code image (i.e., second code version). The generator may communicate update information/update packages to the DM network 105 via a communication path that may comprise a wired or wireless network such as those listed above.

A representative embodiment of the present invention may be employed not only with mobile devices such as those discussed above, but also with other types of electronic devices that comprise non-volatile memory with resident software that comprises a notification client 125, a DM client 163, and is updateable by an update agent 115 in the electronic device.

As shown in the illustration of FIG. 1, the non-volatile memory 111 of the mobile device 107 comprises the update agent 115, a boot loader 113, firmware 137, an operating system (OS) 119, and applications 127.

In a representative embodiment of the present invention, the notification client 125 is sent a notification message by the DM server to indicate the need to conduct a device management task on the mobile device 107. In response, the notification client displays the message received, which could be a multiple choice message. The user's response is also solicited. When the user responds, the user's response is communicated back to the DM server, or to another server. The user response may be communicated over one of the available communication means, such as SMS, a DM session over a OMA DM protocol, etc.

In general, if a multiple choice message is displayed by the notification client, the user's selection is communicated to the DM server. This, in a related embodiment, requires the notification client to collect the user response, communicate it to the DM client 163, for delivery to the DM server. The DM client opens a new DM session, if one is not currently open, and communicates the user response to the DM server. For example, if the notification message indicates the need to start a firmware update operation, and a multiple choice user opt-in (OK, Cancel, Defer, Schedule) is presented to the user, the user may select OK (one of the choices) and the user selection is communicated to the DM client 163 by the notification client 125, which then opens a DM session to the DM server 109 and communicates, via a client-initiated Alert message, the user's response. The DM server, in response, communicates a PkgURL value to the DM client 163, the PkgURL referring to the URL of an update package that may be downloaded by the DM client. And so on.

In one embodiment, the DM client 163 subsumes the notification client 125, and supports then receiving and display of notification messages. It also supports the communication of user opt-in responses to the DM server, using the OMA DM protocol (also called Sync ML) or other means, such as device initiated SMS.

In one embodiment, the set of items that comprises the multiple choice is a standard set that is sent to all devices by the DM server 109, i.e. devices of all Make, Model and version, such that all users see the same multiple-choice. Thus, the set of multiple-choice is used as a standard set. For example, the set comprises an OK, Cancel, Defer, Schedule, Never, wherein the OK indicates user's consent/approval for starting the associated DM task immediately, the Defer indicates the user's refusal to start the DM task right away but letting the DM server (operator) start it automatically sometime later, the Schedule employed to provide a user-convenient date and time for the DM task, and Never indicating a rejection by the user such the DM task is not conducted.

The DM network 105 also comprises a campaign website 167 that supports managing a campaign for conducting a DM activity over a period of time across a plurality of devices. For example, for firmware update over-the-air (FOTA), a FOTA campaign website 167 is employed, which provides release notes for firmware updates along with estimated times for download of firmware update packages and installation of the update packages (i.e. update of firmware). Such information is device specific, and the URL for the appropriate website page for a given device of a make, model, version is retrieved by the DM server 109 and sent to a device 107 (i.e. to the DM client 163 or notification client 125). The FOTA website can then be accessed by the DM client 163 or the Notification client 125 (or even a browser in the device) using the URL of the appropriate website page at the FOTA campaign website 167. A user receiving a notification may chose to review the detailed information of a DM task for which a notification message is received and reviewed by the user of the mobile device 107. For example, in the case of a notification for a firmware update, the user can use the URL provided in the notification to access the FOTA campaign website 167 and review the estimated download time, estimated update time, and the release notes from the FOTA campaign website 167.

The notification message may comprise of a message that is displayed to the user and a multiple-choice of user opt-in options. The user is expected to view the message that is displayed and choose one (or more if multiple selection is allowed) of the choices. The notification may also comprise of the URL of the appropriate release notes 171 hosted by the FOTA campaign website 167, the release notes being supplemented by estimated times 173, which may be computed based on device make, model version and capability, or provided as static data. User response (selection of one of the choices presented) is communicated to the DM server 109, using OMA-DM protocol in one embodiment, or a device initiated SMS message in another. Other protocols are also contemplated, such as 802.11b, TCP/IP, HTTP, etc.

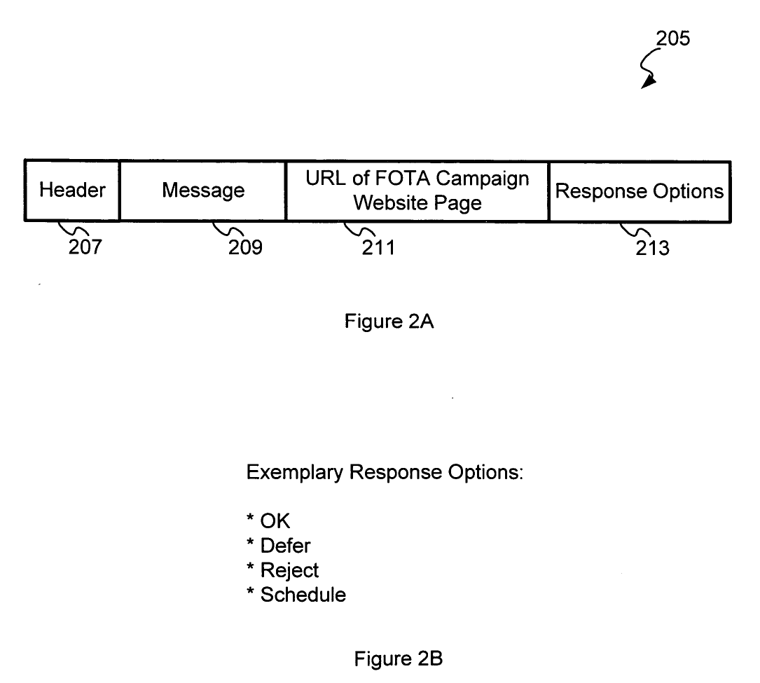

FIG. 2A depicts the structure of a representative notification message communicated by the DM server to the device, that comprises a header 207, a message to be displayed to the user 209, a URL of a Campaign website page, such as a FOTA campaign website page 211 and a response options 213. The response options typically comprises a multiple choice set of options that is to be displayed, from which the user is expected to select one (opt-in).

In one embodiment, the header comprises a correlator that is returned by the DM client in a Generic Alert message sent to the DM server along with the user response to a user opt-in message. In another embodiment, the header comprises a digital signature of the DM server (or operator) that is verified by the notification client or the DM client before the notification and associated response options are displayed to the user.

FIG. 2B is an exemplary response options that is displayed to a user. It comprises a set of 4 choices—OK, Defer, Reject and Schedule. The user can select one of these when it is displayed along with a notification message 209 received by the mobile device. When the user selects Schedule, the user is prompted for a schedule and the user can enter a date and a time for rescheduling the management task associated. This schedule provided by the user is communicated to the DM server and the DM server initiated (begins) the associated DM tasks, such as download of an update package or the initiation of the update of firmware, as per the schedule. If the user selects Defer, the DM server gets to decide when the associated management task needs to be initiated subsequently, without the need to seek opt-in again. AN OK would indicate approval by the user and the associated DM task is started immediately by the DM server (or DM client, if applicable). A Reject, if selected by the user, would indicate rejection of the management task by the user, with the understanding that the user is not likely to ever accept it. The DM server implementations may, at some point in the future, seek approval again, but the user is not likely to see the repeat of the notification message for the same DM task again.

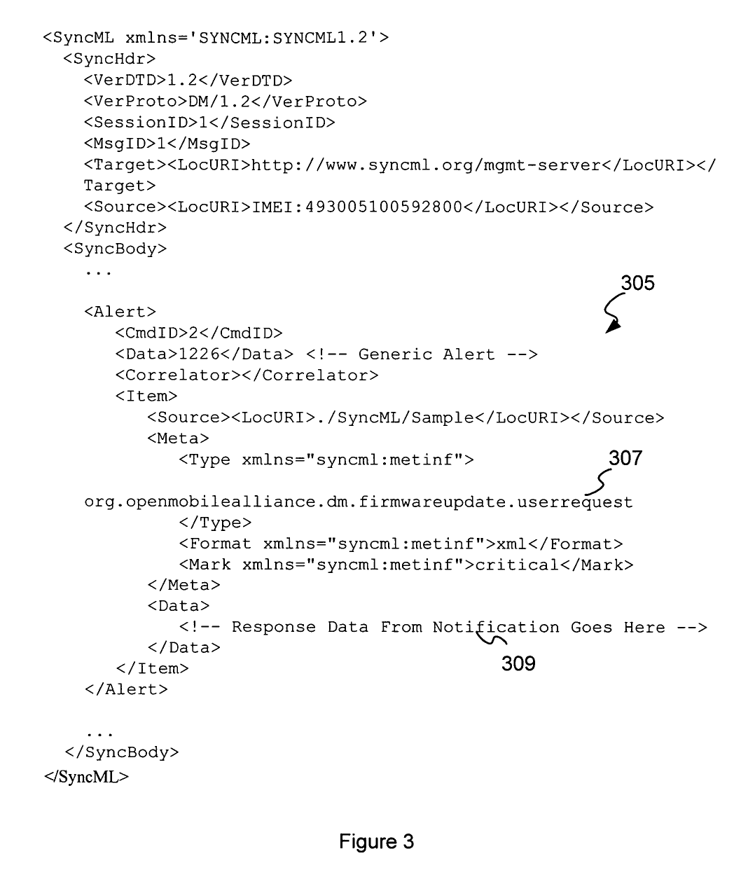

FIG. 3 is an exemplary OMA DM message 305 that is used by the DM client to communicate the user opt-in selection to the DM server, the user opt-in selection having been inferred based on user selection of one item from a multiple-choice options presented to the user. The DM message 305 comprises a Generic Alert with Alert value of 1226, and an associated Alert type 307, such as the org.openmobilealliance.dm.firmwareupdate.userrequest that is communicated by the DM client to the DM server to indicate the associated DM activity. The use of the Generic Alert message with Data of 1226 along with one Item that comprises the response data from the user for the notification, makes it possible for the DM server to determine the user response and a course of action to be taken. In one embodiment, the Alert 1226 is preceded by an Alert 1201 in the same message, to indicate client-initiated DM session.

In one embodiment, the header of the notification message provides the correlator that the DM client returns along with the response. In a different embodiment, the DM client creates it's own correlator and sends it to the DM server in an Alert 1226 along with a response from the user.

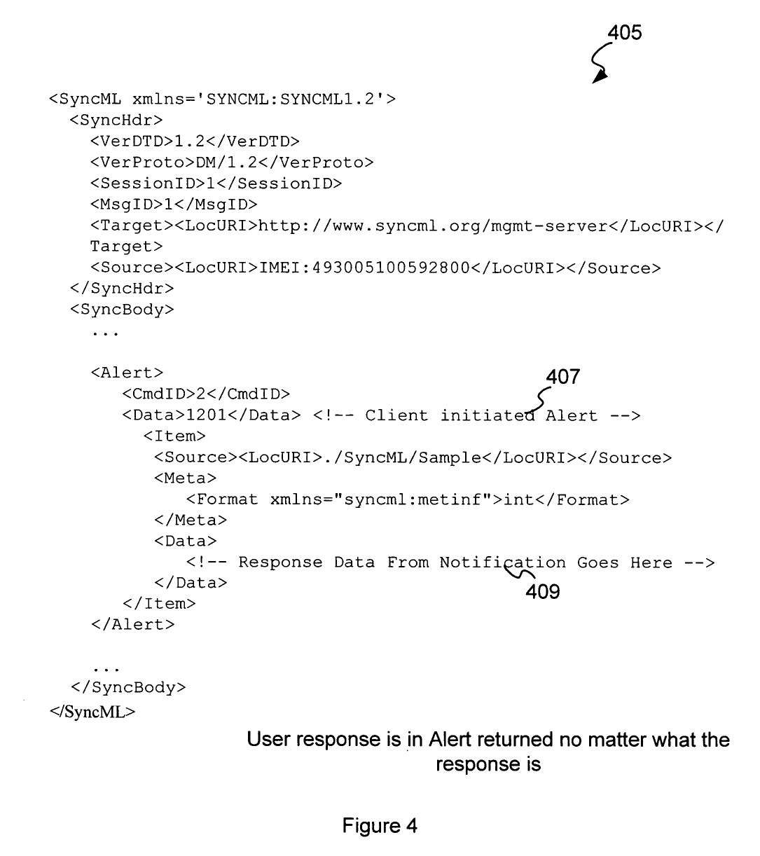

FIG. 4 is another exemplary OMA DM message 405 that is used by the DM client to communicate the user opt-in selection to the DM server, the user opt-in selection having been inferred based on user selection of one item from a multiple-choice options presented to the user. The DM message 405 comprises a client-initiated Alert, indicated by the 1202 data included. A response data from the notification 409, indicating user selection of one of the choices from a multiple choice opt-in presented to the user as part of the notification, is communicated by the DM client to the DM server. For example, if the user selected OK, from the multiple choice options shown in FIG. 2B, the index 1 may be sent by the DM client in the Data element 409. In a related embodiment, each of the choices in the multiple choice options is provided a choice code (such as 21, 22, 23, and 24) and a choice code, such as 21, is returned in the Data element 409. In a different embodiment, the actual text of the individual choice items, such as “OK” or “Reject”, is returned in the Data field 409, with the Meta field set appropriately.

In one embodiment, a device management network 105 comprises a DM server 109 that manages a device 107. The device management network 105 comprises the DM server 109 that comprises a notification interface that it uses to communicate a notification to the device. The DM server also comprises a DM client 163 in the device and a notification client 125 in the device. The notification client 125 receives a notification communicated by the DM server 109. In addition, the notification client 125 displays a message received in the notification and solicits a user response. The user response received by the notification client 125 is communicated to the DM server 109.

In a related embodiment, the device management network 105 wherein the user response received by the notification client 125 is communicated to the DM server 109 via the DM client 163. In another related embodiment, the notification also comprises a multiple-choice selection that is displayed by the notification client 125 and wherein the user response received is one of the multiple-choice selection that is selected by the user.

In yet another embodiment, the notification client 125 and the DM client 163 are combined into a combined client.

In one embodiment, the notification client 125 receives the notification message, displays it and solicits a user response, and communicates the user response to the DM client 163 which subsequently communicates the user response to the DM server 109 over a OMA DM protocol. In a related embodiment, the DM client 163 employs a generic alert message to communicate the user response to the DM server 109. In another related embodiment, the DM client 163 employs a generic alert message to communicate the user response and a correlator from the notification message to the DM server 109.

In one embodiment, the notification message is associated with a management task to be conducted in the device. The DM client 163 employs a generic alert message with an appropriate alert type associated with the management task to communicate a user response to the DM server. In a related embodiment, the DM client 163 employs a client-initiated alert message to communicate the user response to the DM server 109. In addition, the multiple choice selection comprises at least one of the choices OK, Defer, Reject and Schedule. The notification client 125 solicits a user schedule from the user for the management task associated with the notification message when the user selects the choice Schedule. The DM client 163 communicates the user schedule to the DM server 109. Again, the notification message may comprise a URL of a website page. The management task associated with the notification message is a firmware update task in one related embodiment. The website page comprises a release notes, an estimated update time and an estimated download time associated with the firmware update for the device.

In a different embodiment, a mobile device 107 is capable of interacting with a device management server 109. The mobile device comprises a device management client capable of receiving a notification message and displaying it and a device management client capable of soliciting user input and communicating it to the device management server. The notification message comprises a URL of a website page. The notification message may further comprise a textual message and a multiple-choice selection that the mobile device displays along with the textual message and the URL.

The notification message may be associated with a management task to be conducted in the mobile device. The URL provides access to a release notes and associated details of the management task. The device management client 163 communicates a user response to the multiple-choice selection displayed to the device management server 109. In a related embodiment, the multiple-choice selection comprises a Schedule. When the user selects Schedule, the device management client prompts the user for a schedule. The device management client collects from the user a date and a time for rescheduling the management task associated. It then communicates it to the DM server 109.

Aspects of the present invention is found in a method of notifying a user of an electronic device about a management task. The method comprises receiving a notification message comprising at least one of a header, a textual information, a URL of a web site with details about the management task and a multiple-choice options and displaying for the user the at least one of the header, the textual information, the URL of the website page with details about the management task and the multiple-choice options the textual message. It also comprises soliciting from the user a user selection and communicating the user selection to a device management server. In a related embodiment, the displaying activity comprises showing the user the textual message, and rendering the multiple-choice options for the user to select. It also comprises providing access to the website page if the user decides to review it prior to the selection of one of the options presented by the multiple-choice options.

While the present invention has been described with reference to certain embodiments, it will be understood by those skilled in the art that various changes may be made and equivalents may be substituted without departing from the scope of the present invention. In addition, many modifications may be made to adapt a particular situation or material to the teachings of the present invention without departing from its scope. Therefore, it is intended that the present invention not be limited to the particular embodiment disclosed, but that the present invention will include all embodiments falling within the scope of the appended claims.

What is claimed is:

1. A device management network wherein a server manages a device, the device management network comprising:
a DM server comprising a notification interface that it uses to communicate a notification to the device;
a DM client in the device;
a notification client in the device;
wherein the notification client receives a notification communicated by the DM server;
wherein the notification client displays a message received in the notification and solicits a user response; and
wherein the user response received by the notification client is communicated to the DM server.

2. The device management network of claim 1 wherein the user response received by the notification client is communicated to the DM server via the DM client.

3. The device management network of claim 1 wherein the notification also comprises a multiple-choice selection that is displayed by the notification client and wherein the user response received is one of the multiple-choice selection that is selected by the user.

4. The device management network of claim 3 wherein the notification client and the DM client are combined into a combined client.

5. The device management network of claim 3 wherein the notification client receives the notification message, displays it and solicits a user response, and communicates the user response to the DM client which subsequently communicates the user response to the DM server over a OMA DM protocol.

6. The device management network of claim 5 wherein the DM client employs a generic alert message to communicate the user response to the DM server.

7. The device management network of claim 5 wherein the DM client employs a generic alert message to communicate the user response and a correlator from the notification message to the DM server.

8. The device management network of claim 5 wherein the notification message is associated with a management task to be conducted in the device and wherein the DM client employs a generic alert message with an appropriate alert type associated with the management task to communicate a user response to the DM server.

9. The device management network of claim 5 wherein the DM client employs a client-initiated alert message to communicate the user response to the DM server.

10. The device management network of claim 5 wherein the multiple choice selection comprises at least one of the choices OK, Defer, Reject and Schedule.

11. The device management network of claim 10 wherein the notification client solicits a user schedule from the user for the management task associated with the notification message when the user selects the choice Schedule and wherein the DM client communicates the user schedule to the DM server.

12. The device management network of claim 5 wherein the notification message comprises a URL of a website page.

13. The device management network of claim 12 wherein the management task associated with the notification message is a firmware update task and wherein the website page comprises a release notes, an estimated update time and an estimated download time.

14. A mobile device capable of interacting with a device management server, the mobile device comprising:
a device management client capable of receiving a notification message and displaying it;
the device management client soliciting user input and communicating it to the device management server; and
wherein the notification message comprising a URL of a website page.

15. The mobile device of claim 14 wherein the notification message further comprising textual message and a multiple-choice selection that the mobile device displays along with the textual message and the URL.

16. The mobile device of claim 15 wherein the notification message is associated with a management task to be conducted in the mobile device and wherein the URL provides access to a release notes and associated details of the management task.

17. The mobile device of claim 16 wherein the device management client communicates a user response to the multiple-choice selection displayed to the device management server;

18. The mobile device of claim 17 wherein the multiple-choice selection comprises a Schedule and wherein, when the user selects Schedule, the device management client prompts the user for a schedule and wherein the device management client collects from the user a date and a time for rescheduling the management task associated.

19. A method of notifying a user of an electronic device about a management task, the method comprising:
receiving a notification message comprising at least one of a header, a textual information, a URL of a web site with details about the management task and a multiple-choice options;
displaying for the user the at least one of the header, the textual information, the URL of the website page with details about the management task and the multiple-choice options the textual message;
soliciting from the user a user selection; and
communicating the user selection to a device management server.

20. The method of claim 19 wherein the displaying further comprising:
showing the user the textual message;
rendering the multiple-choice options for the user to select; and
providing access to the website page if the user decides to review it prior to the selection of one of the options presented by the multiple-choice options.
